(19) United States
(12) Patent Application Publication
(10) Pub. No.: US 2003/0173040 A1
(43) Pub. Date: Sep. 18, 2003

(54) Unitary flexible roll-up door

(76) Inventors: Calvin L. Court, Texarkana, TX (US); Melvin T. Court, Texarkana, TX (US)

Correspondence Address: Joshua A. Griswold, Jenkens & Gilchrist, P.C., 1445 Ross Avenue, Suite 3200, Dallas, TX, 75202-2799, US

(21) Appl. No.: 10/379,629

(22) Filed: Mar. 5, 2003

Related U.S. Application Data
(63) Continuation-in-part of application No. 10/101,029, filed on Mar. 18, 2002.

(51) Int. Cl. E06B 9/00

(52) U.S. Cl. 160/230; 160/264; 160/37

(57) ABSTRACT

A roll-up door assembly for a variety of uses for example commercial vehicles, commercial buildings, residential buildings or other suitable purposes. The door assembly includes a flexible unitary panel constructed from a material comprising a fiber and resin composite. A plurality of transverse support bars are affixed to the flexible panel. Rollers are rotably mounted on an axle and are adapted to be received in a track for guided movement of the flexible panel. The axle can be integral with the transverse reinforcement member or part of a roller bracket affixed to the transverse reinforcement member. Alternately, the flexible panel can be provided without rollers and can be received in and guided by a slotted track.

This application is a continuation-in-part of U.S. application Ser. No. 10/101,029 filed Mar. 18, 2002.

### BACKGROUND OF THE INVENTION

1. Technical Field of the Invention

The present invention relates generally to overhead or roll-up doors, and in particular to an overhead door made using composite materials.

2. Description of Related Art

An overhead or roll-up door is a type of door in which the door assembly is guided between an opened and closed position on a track affixed about the doorway. Overhead doors are generally constructed from materials like steel, aluminum or wood, and are in the form of multiple panels that are joined to one another and articulate about an axis transverse to the direction that the door moves. The articulation between individual panels is normally achieved either by hinges or by profiling the opposing side edges of the individual panels such that the profiled areas movably interlock with one another.

One overhead door structure is illustrated in U.S. Pat. No. 4,860,813 to Ballyns. The door has multiple panels joined together by hinges. A guide track is positioned at the edges of the door and rollers extending from the hinges are received by the guide track. A disadvantage of an overhead door of this type is that metal panels are prone to denting, scratching, marring or other similar damage. In addition, the articulation between individual panels can degrade with time, and may result in leakage from between seams of the individual panels. Dirt lodged between the individual panels exacerbates wear. Furthermore, if the individual panels are made of metal, the weight becomes relatively high and the metal sheet may rust or corrode over time. If made of wood, the panels are subject to warpage and water damage.

Therefore, there is a need for an overhead or roll-up door that eliminates the drawbacks associated with articulation between individual panels and problems associated with leakage, appearance, weight and corrosion of the prior overhead doors.

### SUMMARY OF THE INVENTION

The above problems are overcome in accordance with the present invention which relates to a roll-up door for a variety of uses for example commercial vehicles, commercial buildings, residential buildings or other suitable purposes. According to the teachings of the present invention, an embodiment of the present invention is directed to a door assembly adapted for guided movement in a track of a roll-up door system positioned in a doorway. The roll-up door system comprises a flexible door panel including a unitary sheet sized to substantially cover the doorway, wherein the unitary sheet is constructed of a material comprising a fiber and resin composite. The system further comprises at least one transverse reinforcement member affixed to an exterior or an interior of the flexible door panel and adapted to engage the track for guided movement therein.

Another embodiment of the present invention is directed towards an insulated roll-up door system. The system comprises a flexible door panel including at least two unitary sheets held in spaced relation and each sized to substantially cover the doorway, wherein the at least two unitary sheets are constructed from a material comprising a fiber and resin composite. The system further comprises at least one transverse reinforcement member affixed to an exterior or interior of the flexible door panel and adapted to engage in the track for guided movement therein.

Another embodiment of the present invention is directed towards an insulated roll-up door system. The system comprises a flexible door panel including at least one unitary sheet sized to substantially cover the doorway, wherein the at least one unitary sheet is constructed from a material comprising a fiber and resin composite and includes insulation thereon. The system further comprises at least one transverse reinforcement member affixed to an exterior or interior of the flexible door panel and adapted to engage in the track for guided movement therein.

An advantage of the invention is that the unitary flexible panel eliminates any leakage from individual panels of the doors and makes the door water resistant.

Another advantage of the invention is that unitary flexible panel made of fiber and resin composite is corrosion resistant and has substantially less weight as compared to metal or wood doors.

Another advantage of the present invention is that the flexible unitary panel eliminates dirt being lodged between individual panels of doors.

Another advantage of the present invention is that the flexible unitary panel made of fiber and resin composite is less prone to denting, scratching, marring or other similar damage.

Another advantage of the present invention is that the flexible unitary panel made of fiber and resin composite eliminates warping, rotting or other similar damage.

Another advantage of the present invention is that the transverse reinforcement member adapted for engagement with an axial support member allows ordinary parts to be used without the need for special machining.

Additional advantages of this invention will become apparent from the following drawings and description of the preferred embodiments.

### BRIEF DESCRIPTION OF THE DRAWINGS

Various objects and advantages of the invention will become apparent and more readily appreciated from the following description of the presently preferred exemplary embodiments, taken in conjunction with the accompanying drawings of which:

FIG. 1 is a simplified perspective view of a van equipped with an overhead or roll-up door system made in accordance with this invention;

FIGS. 2a and 2b are interior views of exemplary roll-up doors;

FIG. 3 is a view of an exemplary stiffener bar;

FIGS. 4a, 4b, and 4c are perspective views of exemplary roller brackets;

FIG. 4d is an enlarged view of an integrated removable roller bracket;

FIG. 5 is a cross-sectional view illustrating an insulated door construction according to the present invention;

FIG. 6 is a cross-sectional view illustrating another insulated door construction according to the present invention;

FIG. 7 is a cross-sectional view illustrating another insulated door construction comprising a single flexible panel according to the present invention,

FIGS. 8a and 8b are cross-sectional views illustrating another insulated door construction according to the present invention; and

FIG. 9 is an enlarged view of a roller integrated into the stiffener bar.

FIG. 10 is a perspective view of a van equipped with an overhead or roll-up door system;

FIGS. 11a and 11b are detail views of the slotted track roll-up door assembly of FIG. 10 illustrating the flexible door panel with alternate configurations of stiffener bars;

FIG. 12 is a cross-sectional view illustrating the slotted track guide frame;

FIG. 13 is a cross-sectional view illustrating the sealing member;

FIG. 14 is a detail view of the slotted track roll-up door assembly of FIG. 10, illustrating the relationship between the stiffener bars, guide frame, and the flexible panel during operation of the roll up door system of FIG. 10;

FIG. 15 is a side cross-sectional view of an exemplary stiffener bar; and

FIGS. 16a-16b are multiple views of an alternate exemplary roller bracket.

### DETAILED DESCRIPTION OF THE EXEMPLARY EMBODIMENTS OF THE INVENTION

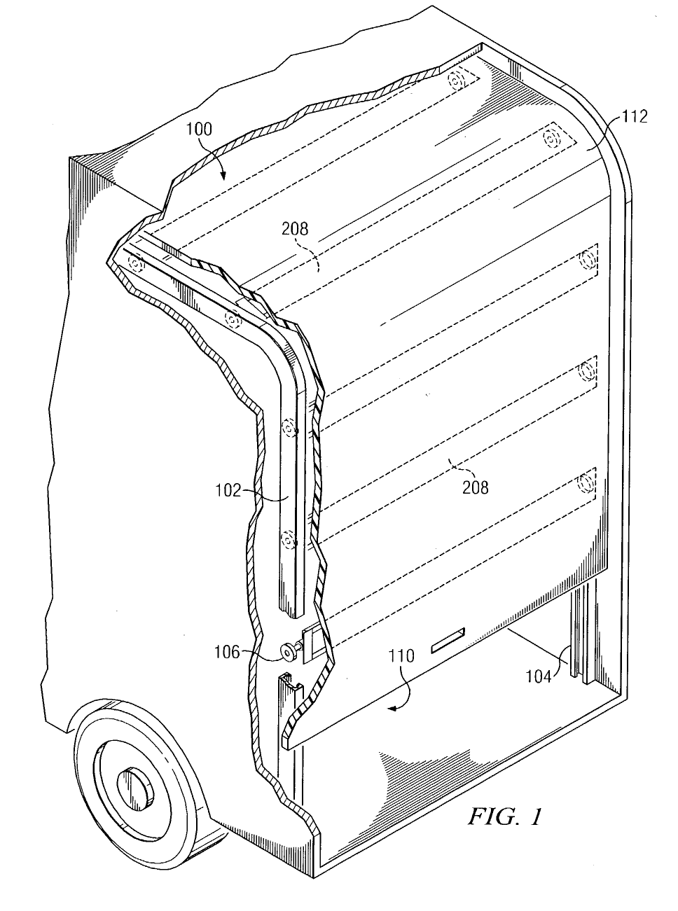

With reference to FIG. 1 of the drawings, an overhead or roll-up door assembly 100 is shown installed in a doorway or opening 110 of a van body. The door assembly 100 includes a unitary, substantially planar, flexible panel 112 having a plurality of rollers 106 distributed in spaced relation on opposite sides of the flexible panel 112. Guide frames 102 and 104 extend vertically, in opposed relation, along the sides of opening 110 and curve to horizontal. Rollers 106 are received in opposed guide frames 102 and 104 to guide the door assembly 100 through a range of motion, including a closed position in which a substantial portion of the door assembly 100 is vertical and covers the opening 110 and an open position in which a substantial portion of the door assembly 100 is horizontal leaving opening 110 substantially unobstructed. FIG. 1 depicts the door assembly 100 positioned part way between the opened and closed positions to illustrate the curvature that the flexible panel 112 must achieve when moved between the opened and closed positions. The guide frames 102 and 104 can have a C-shaped profile that retainingly receives the rollers 106.

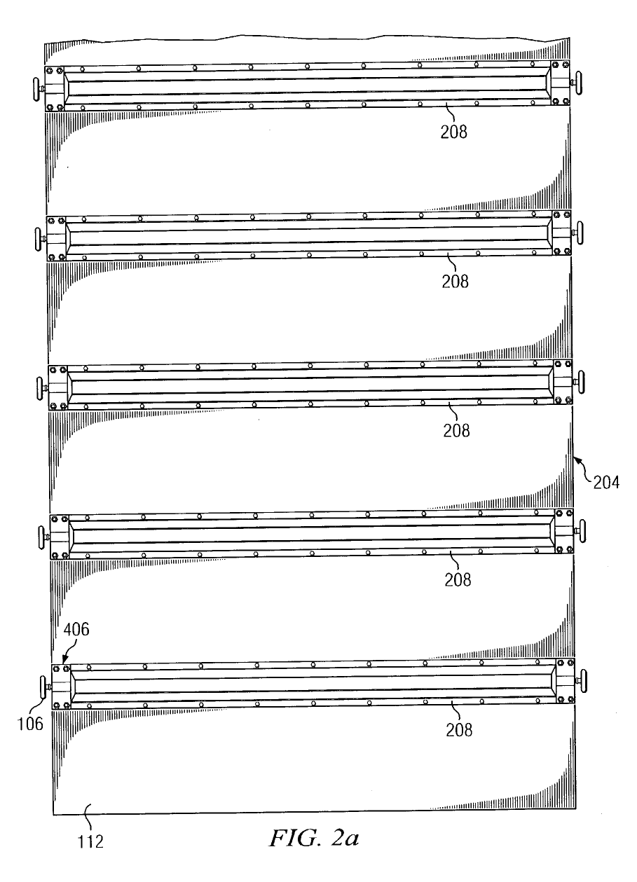

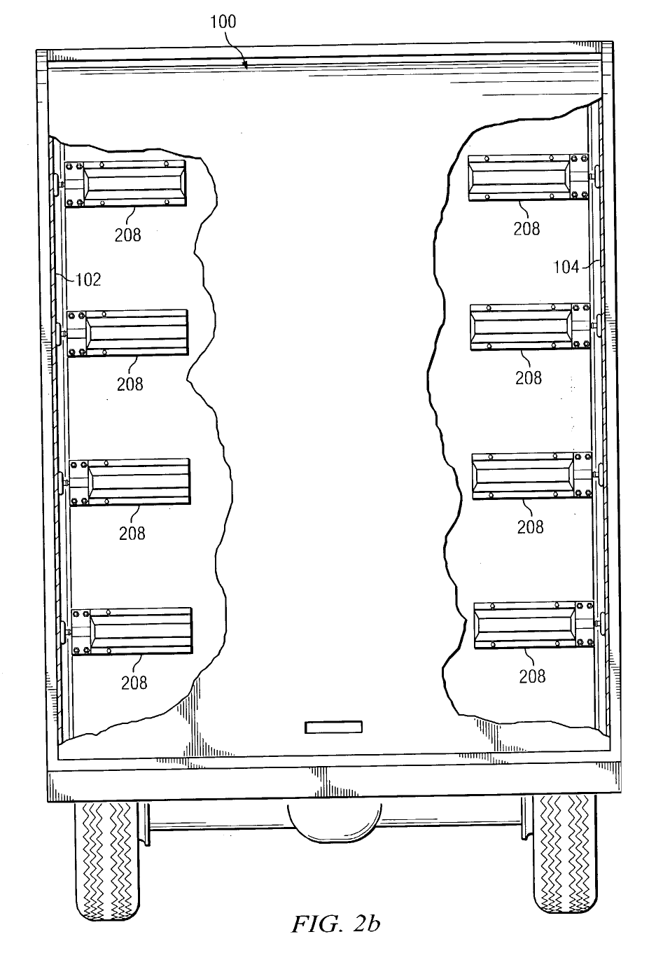

Referring to FIGS. 2a and 2b of the drawings, interior views of the door and its construction will be described in detail. The panel 112 can be constructed from a unitary sheet of material comprising a fiber and resin composite. The flexible panel 112 is sized to substantially cover the opening 110 (FIG. 1). The fiber can include virtually any fibrous material, for example but in no means by limitation, fiber glass, aramid fiber (e.g. KEVLAR, a registered trademark of I. E. du Pont de Nemours and Company), carbon fiber, and combinations thereof. The fibers can be of a type that have very little elasticity when loaded in tension and can be woven in a pattern similar to fabric or can be matted. The resin can be virtually any polymer resin that can bind the fibers to form a sheet. Further, the fiber and resin composite can be a single layer of fibers bonded by resin or multiple layered, and include additional materials, for example polymer films. Two examples of fiber and resin composites suitable for use in the flexible panel 112 of the invention include ARMORTUF (a registered trademark of Kemlite Company, Inc.) and BULITEX (a registered trademark of LLC DBA U.S. Liner Company). Also, flexible panel 112 can be constructed from polymer sheet material that may be reinforced by a fiber and resin composite. In any case, the flexible panel 112 as used herein is such that it will not substantially stretch in the plane of the panel, but can be flexed in a direction perpendicular to the plane of the panel without substantial plastic deformation or breakage and then recover or flex back to its original planar shape.

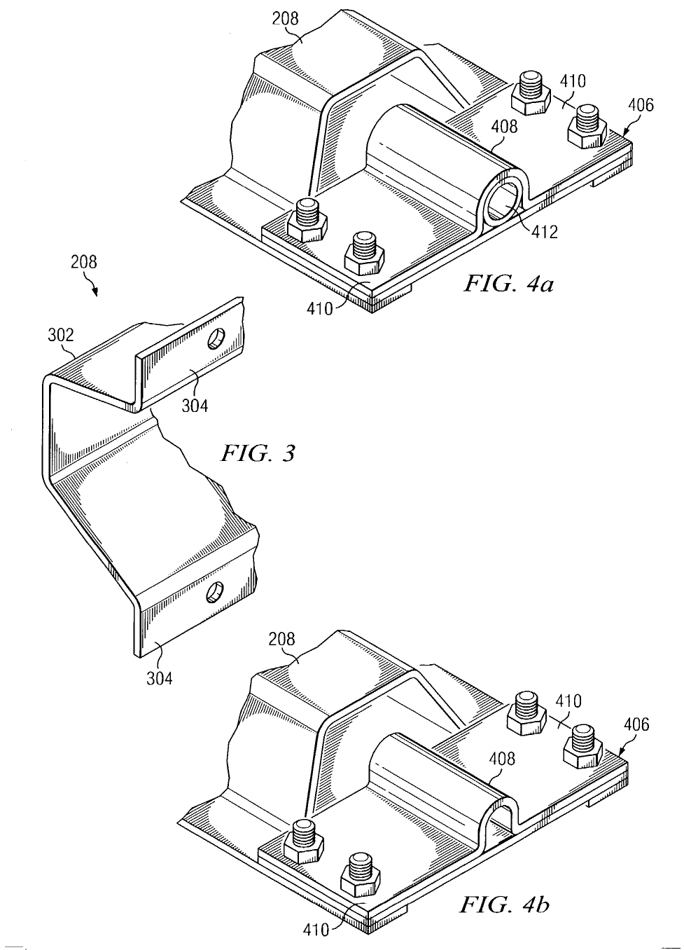

A plurality of stiffener bars 208 are affixed transversely across the width of the flexible panel 112, either continuously (see FIG. 2a) or partially (see FIG. 2b). The plurality of stiffener bars 208 can be fixed on the exterior or interior of the flexible panel 112 for reinforcement. In the vertical position shown, the stiffener bars 208 are horizontally arranged substantially parallel to each other. When mounted on the flexible panel 112, the stiffener bars 208 provide rigidity in a direction perpendicular to the plane of the panel 112 and support the rollers 106. An exemplary stiffener bar 208 is depicted in FIG. 3 having a deep channel section 302 with flange portions 304 adjacent the channel section 302. Other stiffener bar 208 shapes can be used with the door of this invention. The stiffener bars 208 may be made of virtually any material for example wood, plastic, steel, aluminum, composites, polymers, or combinations-thereof, or other suitable material and connected to the flexible panel 112 by adhesives, mechanical fasteners or other convenient means.

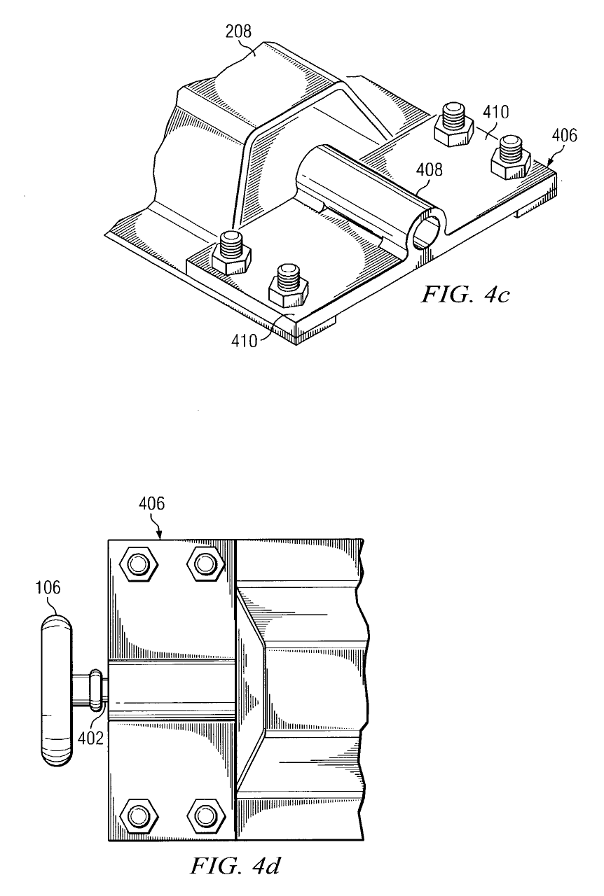

FIGS. 4a, 4b, and 4c depict exemplary roller brackets 406 which can be connected at opposing ends of the stiffener bars 208 or at ends of partial bars. Referring first to FIG. 4a, one exemplary roller bracket 406 has a circular channel section 408 with substantially planar flange portions 410 adjacent the circular channel section 408. The channel section 408 and flange portions 410 can be formed from a single piece of material, for example a piece of plate bent to include the channel section 408 and flange portions 410 as seen in FIG. 4a. The flange portions 410 of the roller bracket 406 abut and are affixed to the flange portions 304 (FIG. 3) of the stiffener bars 208 by welding, adhesives, or mechanical fasteners such as screws, bolts, rivets or other convenient means. The roller bracket 406 of FIG. 4a further comprises a cylindrical bushing 412 held closely within the circular channel section 408. The cylindrical bushing 412 receives a roller axle 402 (FIG. 4d) on which a roller 106 is rotably mounted. Alternatively, referring to FIG. 4b the roller bracket 406 can be configured to receive the roller axle 402 directly within the circular channel section 408 and does not incorporate the cylindrical bushing 412 as described earlier with reference to FIG. 4a. In another exemplary embodiment, the cylindrical bushing 412 can be affixed directly onto the flange portions 410 as shown in FIG. 4c for example by welding, adhesives or other convenient method. FIG. 4d provides an enlarged illustration of a roller bracket 406 assembled with a roller 106 and roller axle 402. The roller bracket 406 including the cylindrical bushing 412 may be formed of steel, but a variety of materials such as other metals, composites, polymers, or combinations thereof may be used.

As seen in FIG. 9, the roller axle 904 can be an integral part of the stiffener bar 902, in which case the roller bracket 406 need not be included. The roller 106 is then rotably mounted to the roller axle 904 of stiffener bar 902 that is mounted to panel 906.

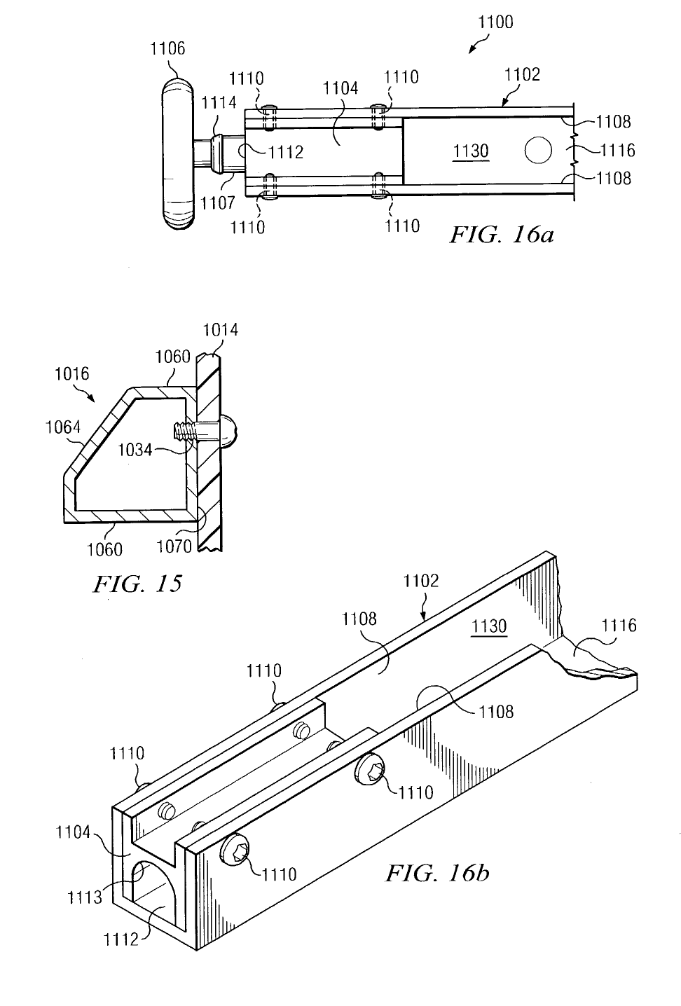

Referring now to FIGS. 16a-16b of the drawings, in combination, there is shown different views of another exemplary roller bracket 1104 and stiffener bar 1102. FIG. 16a depicts a top view of the roller bracket 1104 and stiffener bar 1102 and FIG. 16b shows a top perspective view of the roller bracket 1104 and support bar 1102. The roller bracket 1104 is received in a cavity 1130 defined by inner walls 1108 and a bottom surface 1116 of the transverse support bar 1102. The roller bracket 1104 may extend partially or fully along the transverse support bar 1102 as can the stiffener bar 1102 extend fully or partially across the width of the flexible panel 112 (see FIGS. 2a and 2b). Furthermore, the roller bracket 1104 is affixed to the transverse support bar 1102 via fasteners 1110. Although there is shown in these particular views four fasteners, other combinations of fasteners 1110 may be used, as well as other methods of affixing the roller bracket 1104 to the stiffener bar 1102. While transverse support bar 1102 is shown in FIG. 16 as a generally U-shaped component, bar 1102 is not necessarily limited to this U-shape and may take on any variety of shapes. One such shape is that illustrated in FIG. 15, which prevents objects from catching on the surface of the transverse support bar 1102. Likewise, while roller bracket 1104 is generally H-shaped, its shaped needs only to conform to the shape of the transverse stiffener bar for sliding engagement, one to another.

The roller axle 1107 is received in an axle receiving slot 1112 of the roller bracket 1104 (see FIG. 16a). The slot 1112 has curved upper surface 1113 (see FIG. 16b) configured to closely receive the curved outer profile of the roller axle 1107 and align a longitudinal axis of the roller axle 1107 substantially parallel to a longitudinal axis of the roller bracket 1104 and the transverse support bar 1102. The slot 1112 is open opposite the curved upper surface 1113 such that the roller axle 1107 abuts the bottom surface 1116 of the transverse support bar 1102 when received in the slot 1112. The roller axle 1107 is held in place by a clamping force exerted by roller bracket 1104 against the transverse support bar 1102 and the lateral force exerted by a track assembly (not shown). Roller axle 1107 is limited in its lateral movement by flange 1114. Although roller bracket 1104 and transverse support bar 1102 are shown as two separate components, they may be formed of one extrusion wherein the roller bracket 1104 is a portion of the transverse support bar 1102.

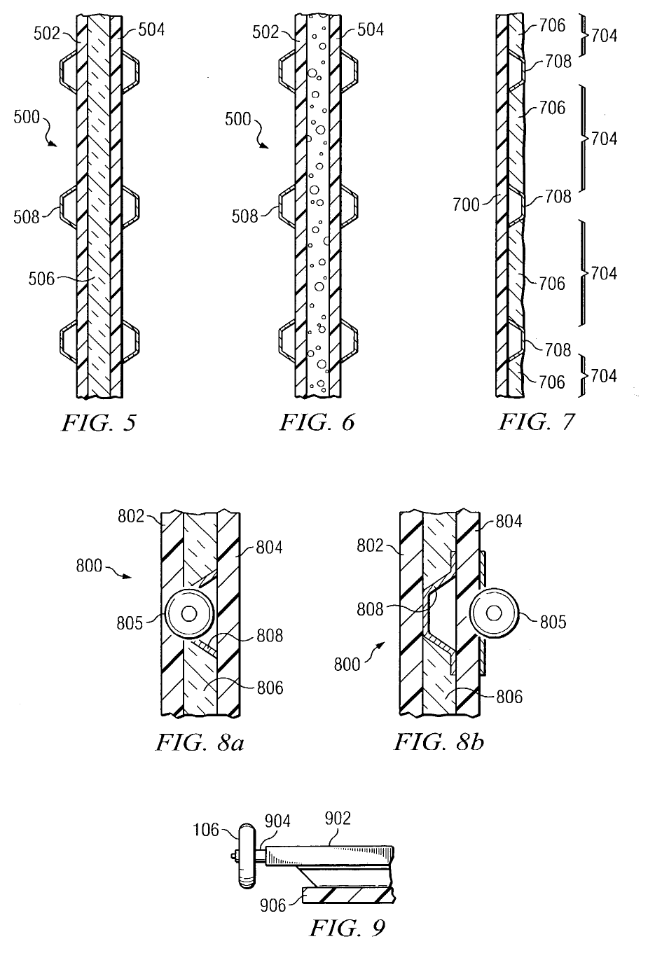

Referring to FIG. 5 of the drawings, the unitary flexible panel 500 comprises a substantially parallel inner sheet 502 and outer sheet 504, each of which are constructed of fiber and resin composites similar to those described above. The construction of the flexible panel 500 is similar to that described earlier with reference to the stiffener bars 208, rollers 106 and roller bracket 406 in FIGS. 2 and 4. Also, the roller can be integrated with the stiffener bars 508 as discussed above. Stiffener bars 508 can be positioned on an exterior surface of the panel 500. The open space between the flexible sheets 502 and 504 is filled with a flexible insulating material 506. In an exemplary embodiment, a flexible foam material is layered into place between the flexible sheets 502 and 504. Virtually, any flexible material is suitable provided that it has good insulating properties and is capable of holding the sheets 502 and 504 in a spaced-apart relation.

Referring to FIG. 6, a gas or air can be used as the insulating material by providing a “dead air” space between the flexible sheets 502 and 504. The construction of the flexible sheets 502 and 504 with respect to the stiffener bars 508 used for transverse reinforcement are substantially the same as that shown in FIGS. 2 and 4.

Referring to FIG. 7 of the drawings, an insulated door using a single unitary flexible panel 700 can be provided. The construction of the flexible panel 700 is similar to that described earlier with reference to the stiffener bars 208, rollers 106 and roller bracket 406 in FIGS. 2 and 4. The stiffener bars 708 may be placed on either the interior or exterior of the flexible panel 700. The space 704 between the stiffener bars 708 is filled with insulating material 706. In an exemplary embodiment, a flexible foam material or polyethylene may be used for insulating. Virtually, any flexible material is suitable provided that it has good insulating properties and adheres to the space 704 between the stiffener bars.

FIGS. 8a and 8b depict a panel 800 similar to that of FIG. 5, but incorporating the stiffener bars 808 inside the panel 800. The unitary flexible panel 800 comprises a substantially parallel inner sheet 802 and outer sheet 804, each of which are constructed of fiber and resin composites similar to those described above. The construction of the flexible panel 800 is similar to that described earlier with reference to the stiffener bars 208, rollers 106 and roller bracket 406 in FIGS. 2 and 4. However, in the present embodiment, the stiffener bars 808 are placed in between the inner sheet 802 and the outer sheet 804. In an exemplary embodiment (FIG. 8a), the roller bracket 805 may be connected to the stiffener bars 808 between the inner sheet 802 and the outer sheet 804. Alternately, the roller bracket 805 can be affixed through the exterior of the panel 800 to the stiffener bars 808 (FIG. 8b). Also, the roller can be integrated with the stiffener bars 808 as discussed above. The open space between the flexible sheets 802 and 804 and the stiffener bars 808 is filled with a flexible insulating material 806. In an exemplary embodiment, a flexible foam material is layered into place between the flexible sheets 802 and 804. Virtually, any flexible material is suitable provided that it has good insulating properties. Also, the insulating material can be air or gas as stated above.

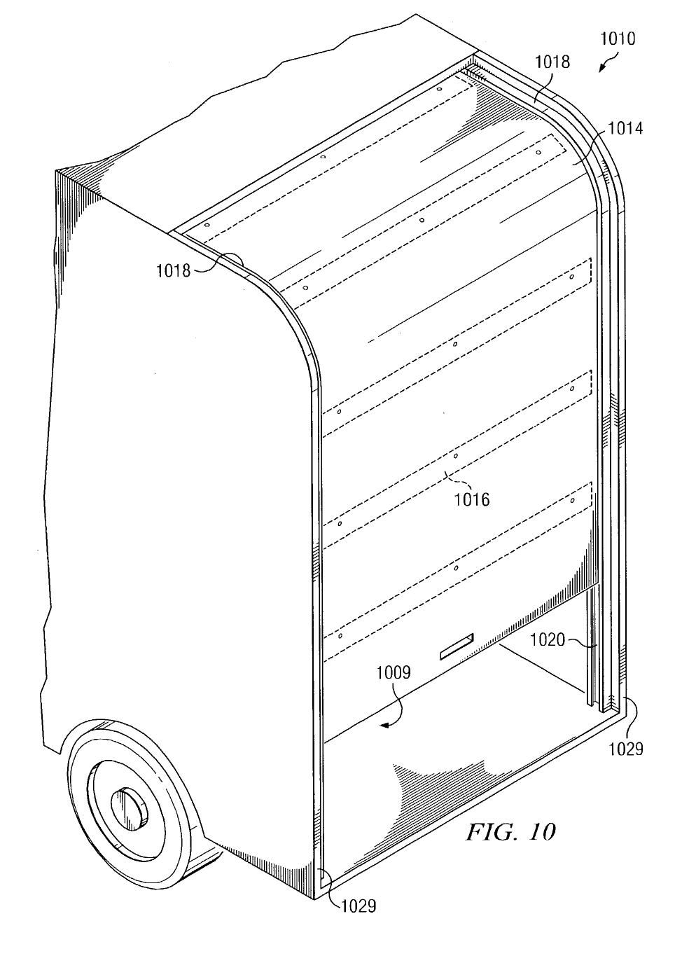

Referring now to FIG. 10 of the drawings, a slotted track roll-up door assembly 1010 is shown installed in a doorway or opening 1009 of a van body. The assembly 1010 of FIG. 10 is similar to the assembly 100 of FIG. 1, except that the guide frames 102 and 104 and rollers 106 have been replaced with slotted track guide frames 1018. The door assembly 1010 includes a unitary, substantially planar, flexible panel 1014, with transverse support bars 1016 attached thereto. The slotted track guide frames 1018 extend vertically, in opposed relation, along the sides of opening 1009 and curve to horizontal. Guiding slots 1020 are provided in each of the slotted track guide frames 1018 and are adapted for sliding engagement of the flexible panel 1014.

Portions of the flexible panel 1014, as discussed in more detail below, are adapted to be received by slots 1020 of the guide frames 1018 to guide the door assembly 1010 through a range of motion, including a closed position in which a substantial portion of the door assembly 1010 is vertical and covers the opening 9 and an open position in which a substantial portion of the door assembly 1010 is horizontal leaving opening 1009 substantially unobstructed. As discussed in more detail below, the slots 1020 of the guide frames 1018 comprise a first and a second portion adapted to retainingly receive the flexible door 1014.

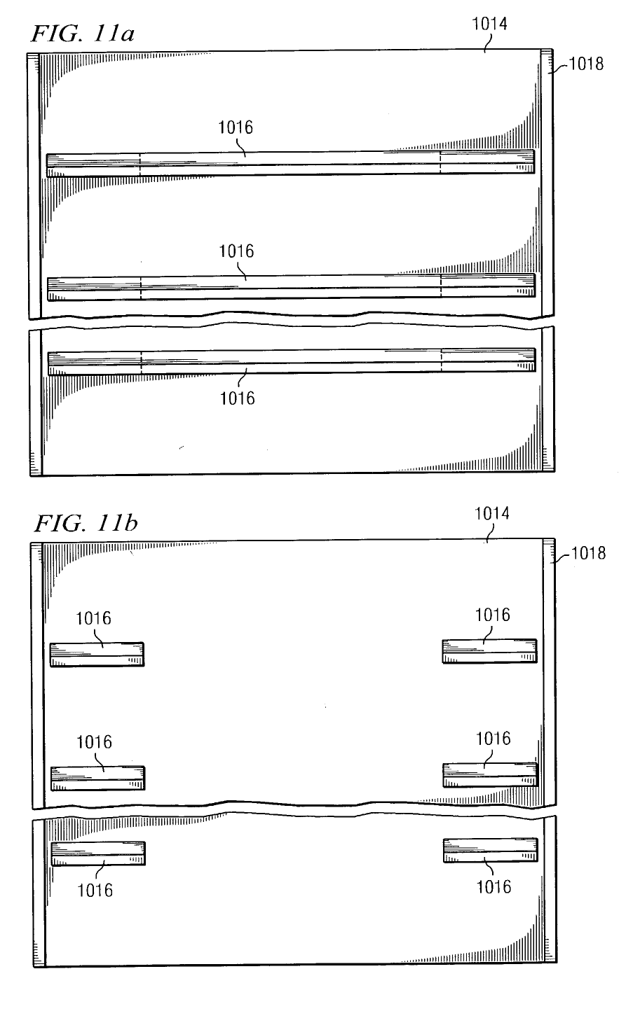

Referring now to FIGS. 11a and 11b in combination, there is shown three alternate embodiments of the flexible door 1014 with transverse support bars 1016. The stiffener bars 1016 are affixed transversely across the width of the flexible panel 1014. The stiffener bars 1016 can be fixed on the exterior or interior of the flexible panel 1014 for reinforcement, and can extend either partially, as shown in FIG. 11b, or continuously, as shown in FIG. 11a, across the width of the flexible panel 1014.

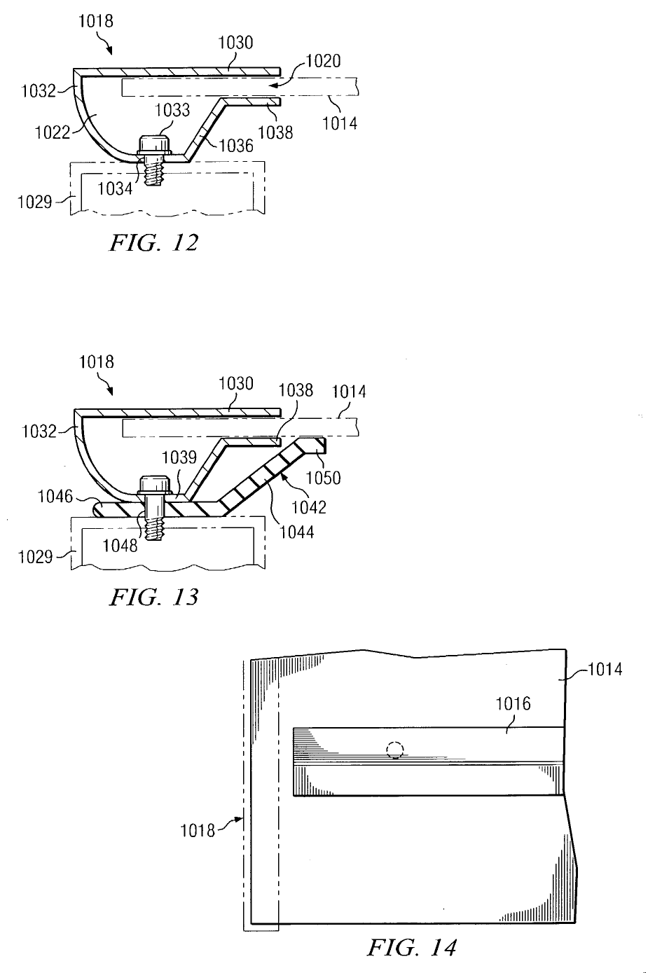

Referring now to FIG. 12, there is shown a cross-sectional view of a single slotted guide frame 1018, of the type discussed in FIGS. 10, 11a and 11b. The guide frames 1018 are constructed with a first guide portion 1030 and a second guide portion 1038 adapted to slidably receive opposing surfaces of the flexible panel 1014. The first portion 1030 defines an upper surface of a slot 1020, while the second portion 1038 defines a lower surface of the slot 1020. A portion of the flexible panel 1030 is slidably received in the slot 1020 of the guide frame 1018. Further, the first portion 1030 and second portion 1038 are spaced so as to prevent the guide frame 1018 from frictionally restraining movement of the flexible panel 1014, while at the same time guiding movement of panel 1014 along the slot 1020.

Referring still to FIG. 12, the guide frame 1018 can optionally be provided with a cavity 1022 in communication with the slot 1020. The cavity 1022 is defined by members 1032 and 1036 and comprises an aperture 1034. Aperture 1034 receives a fastener 1033 that affixes the guide frame 1018 to a door frame 1029, shown in phantom, to support the roll-up door assembly 1010 of FIG. 10.

Referring now to FIG. 13, there is shown a cross sectional view of the guiding frame 1018 of FIG. 10 incorporating a sealing member 1042. The sealing member 1042 is shown disposed between a lower section 1039 of the guide frame 1018 and the door frame 1029. The sealing member 1042 comprises a first portion 1046 having an aperture 1048 therein and adapted to allow coupling of the guide frame 1018 to the door frame 1029. The sealing member 1042 further comprises an angulated portion 1044 extending from the first portion 1046 at an acute angle relative thereto, and having a terminal end 1050 abutting the panel 1014. The sealing member 1042 is adapted to substantially prevent passage of particulate between the sealing member 1042 and the flexible door 1014.

Referring now to FIG. 14, there is shown a detail view of the flexible panel 1014 along with stiffener bar 1016. Slotted guide frame 1018 is shown in phantom. As is clearly seen in FIG. 14, a portion of the flexible panel 1014 is closely received in the guiding mechanism 1018, for guided movement thereof, as discussed above in relation to FIG. 12. The stiffener bars 1016 do not engage the slotted guide frame 1018.

Referring now to FIG. 15, there is shown a side cross-sectional view of an exemplary stiffener bar 1016. In this particular embodiment, the stiffener bar 1016 comprises a first surface 1070 abutting the flexible panel 1014, and an angulated second surface 1064 at an acute angle with the first surface 1070. The first surface 1070 and the second surface 1064 can be coupled in any number of ways, but as shown in FIG. 15, horizontal support surfaces 1060 extend outwardly from the first surface 1070 and couple the second surface 1064 thereto. The angle of the second surface 1064 tends to prevent objects in contact with the stiffener bars 1016 from obstructing the operation of the slotted track guiding assembly 1010 of FIG. 10. For example, during transit, boxes and crates stored near the opening 1009 of the van body of FIG. 10 will shift and come to rest on the stiffener bars 1016. Opening the flexible panel 1014 is significantly less difficult with the stiffener bar 1016 having the angulated surface 1064, which allows the obstructing boxes and crates to slide off rather than restrain movement of the stiffener bar 1016.

In operation, with reference to FIGS. 10, 12 and 13, the flexible panel 1014 is received in the slots 1020 of opposed guiding frames 1018, and is manipulated up or down without the aid of the rollers 106 (FIG. 1). The guiding frames 1018 extend along the door frame 1029 of the doorway 1009 to guide the flexible panel 1014 as it engages the slot 1020, between the up or down position. In one embodiment, the guiding frame 1018 is adapted to prevent the accumulation of particulate within the slot 1020 by the addition of the sealing member 1042, as shown in FIG. 13.

Manufacture of the slotted track roll up door assembly 1010 of FIG. 10 does not require the addition or alignment of the roller 106, as in FIG. 1. Further, the possibility of a malfunction as the door is moving is minimized with the slotted track roll up door assembly 1010 of FIG. 10, because the assembly contains fewer moving parts as compared to the roll up door assembly of FIG. 1.

The stiffener bars 1016 may be shaped in any number of configurations, but the exemplary embodiment of FIG. 15 is advantageous because of the angulated surface 1064 opposite the surface 1070 which abuts the flexible panel 1014. The angulated surface 1064 prevents material, such as boxes or crates, from becoming caught on the reinforcement member 1016, thereby preventing movement of the flexible panel 1014. Also, the costs of the stiffener bars 1016 with the angulated surface 1064 (FIG. 15) are reduced because less material is required in their construction. Finally, with less material required for construction, the weight of the stiffener bars 1016 is reduced.

Due to the use of fiber and resin composite, the weight of the door of the present invention is considerably reduced in comparison to the multiple articulated panels used in prior doors. Since the flexible panel of the present invention comprises a unitary panel, this eliminates any leakage from seams or individual panels. Also, the fiber composite flexible panel is water resistant and not subject to warping like a wooden articulated multiple panel door. Furthermore, the fiber and resin composite used to construct the flexible panels of the present invention is rust proof.

Fiber composites have a lower rate of heat transfer, thus the flexible panel will not transmit heat through the opening or become hot to the touch as readily as a metallic door. The fiber composites used to construct the flexible panel can be chemical resistant. Unlike prior art designs that have incorporated the support structure into the door, mounting the support bars on the exterior or the interior of the flexible panel allows the two components to be fabricated separately. Thus, pre-fabricated flexible panels and support bars can be used to reduce manufacturing costs. Finally, the door assembly can be configured to retrofit to existing systems.

The flexible panel can be constructed of fiber composite that is translucent to transmit light into the opening, for example, by use of a translucent fiber and/or translucent resin. Coloration can be introduced to the resin to produce colored flexible panels, either translucent or opaque. Also, different colored fibers can be used to introduce coloration. The flexible panel can be surface coated, for example with paint or gelcoat. Since fiber composites are less prone to denting, scratching, marring or other similar damage, the flexible panel will remain aesthetically attractive over time. If the color is introduced to the resin or fibers, the coloration will not scratch or wear off the flexible panel.

It is understood that variations may be made in the foregoing without departing from the scope of the invention. Although embodiments of the invention have been illustrated in the accompanying Drawings and described in the foregoing Detailed Description, it will be understood that the invention is not limited to those embodiments disclosed, but is capable of numerous rearrangements, modifications and substitutions as may be included in the spirit and scope of the invention as defined in the following claims.

We claim:

1. A roll-up door system positioned in a doorway, the roll-up door comprising:
a track assembly;
a flexible panel including a unitary sheet sized to substantially cover the doorway, wherein the unitary sheet is constructed of a material comprising a fiber and resin composite; and
at least two transverse reinforcement members affixed to the flexible panel, wherein at least one of the transverse reinforcement members extends at least part way across a width of the flexible panel.

2. The door system according to claim 1, wherein said flexible panel is made of fiberglass.

3. The door system according to claim 1, wherein said flexible panel is translucent.

4. The door system according to claim 1, wherein said flexible panel is opaque.

5. The door system according to claim 1, wherein said flexible panel is rust proof.

6. The door system according to claim 1, wherein said flexible panel is water resistant.

7. The door system of claim 1, wherein the track assembly comprises a first guide portion spaced from a second guide portion, the first and second guide portions adapted to closely receive the flexible panel and guide movement of the panel therein.

8. The door system of claim 1, wherein the flexible panel further comprises a second unitary sheet panel spaced from the first mentioned unitary sheet to define a cavity therebetween.

9. The door system of claim 8, wherein the cavity contains polyethylene material.

10. The door system of claim 8, wherein the cavity contains a foam material.

11. The door system of claim 1, wherein at least one of the transverse reinforcement members comprises:
a first surface abutting the flexible panel; and
a second surface that forms an acute angle with the first surface.

12. The door system of claim 1, wherein at least one of the transverse reinforcement members comprises:
a U-shaped channel affixed to the flexible panel; and
a second member received in the U-shaped channel, the second member having a slot adapted to receive an axle.

13. The door system of claim 12, wherein the second member is adapted to clamp the axle against the U-shaped channel.

14. A rollerless roll-up door system positioned in a doorway, comprising:
a flexible door panel sized to substantially cover the doorway;
at least one slotted track in the doorway having a first guide portion spaced from a second guide portion, the first and second guide portions are adapted to closely receive the flexible door panel and guide movement of the door panel therein.

15. The door system of claim 14, wherein the track further comprises a seal member adjacent the flexible door adapted to substantially prevent passage of particulate between the seal member and the flexible door.

16. The door system of claim 14, wherein the track is curved so as to allow the flexible door to transition from a vertical position to a horizontal position.

17. The door system according to claim 14, wherein said flexible panel is made of fiberglass.

18. The door system according to claim 14, wherein said flexible panel is translucent.

19. The door system according to claim 14, wherein said flexible panel is opaque.

20. The door system according to claim 14, wherein said flexible panel is rust proof.

21. The door system according to claim 14, wherein said flexible panel is water resistant.

22. The door system according to claim 14, further comprising at least two transverse stiffener bars affixed to the flexible panel, wherein at least one of the transverse stiffener bars extends at least partially across a width of the flexible panel.

23. The door system of claim 14, wherein at least one of the transverse stiffener bars comprises:
a first surface abutting the flexible panel; and
a second surface that forms an acute angle with the first surface.

24. The door system of claim 14, wherein at least one of the transverse reinforcement members comprises:
a U-shaped channel affixed to the flexible panel; and
a second member received in the U-shaped channel, the second member having a slot adapted to receive an axle.

25. The door system of claim 24, wherein the second member is adapted to clamp the axle against the U-shaped channel.
